(19) United States
(12) Patent Application Publication
(10) Pub. No.: US 2013/0318708 A1
(43) Pub. Date: Dec. 5, 2013

(54) DEVICE FOR TURNING OVER AND TRANSFERRING THE PATIENT

(71) Applicant: YI-LONG WANG, KEELUNG CITY (TW)

(72) Inventor: YI-LONG WANG, KEELUNG CITY (TW)

(21) Appl. No.: 13/904,242

(22) Filed: May 29, 2013

(30) Foreign Application Priority Data
May 30, 2012 (TW) 101119329

(51) Int. Cl. A61G 7/10

(52) U.S. Cl. CPC A61G 7/1003; A61G 7/1019
USPC 5/87.1; 4/562.1

(57) ABSTRACT

A device for turning over and transferring the patient comprises a base, a lifting mechanism, an extension arm, a cantilever beam, and a turn driving device. The lifting mechanism comprises a lifting post and a lift driving device. The lifting post is fixed to the base; the lift driving device is fixed to the lifting post. The extension arm has a first end and a second end. The lift driving device is operatively connected to the first end for driving the extension arm to move up and down along the lifting post. The cantilever beam is connected to the second end and extending away from the lifting post. The turn driving device comprises a motor reducer, a revolutionary shaft, and two turning shafts.

### FIELD OF THE INVENTION

The present invention relates generally to a device for turning over and transferring the patient, and particularly to a medical assistive device for care and rehabilitation applications.

### BACKGROUND OF THE INVENTION

In the coming aged society, the bodies of many apoplexy patients, patients in the vegetative state, or bedridden patients degenerate due to lack of activities. If not turned periodically, they may suffer from bedsores. Thereby, caregivers and care equipment are required for their daily cares. It is a tiresome and heavy duty to take care a bedridden patient in a long time. For improving the caring abilities as well as relieving the burden of labor for caregivers, convenient and labor-saving care and rehabilitation apparatuses are highly required.

Currently, the care and rehabilitation apparatuses for caring bedridden patients in the market include:
1. Turning bed: includes a single application of turning a bedridden patient.
2. Inflatable bed: includes a single application of changing the pressure points of the body of a bedridden patient for preventing bedsores.
3. Electric shifting machine: includes the application of moving and weighing a bedridden patient.
4. Phlegm suction machine: includes a single application of phlegm suction for a bedridden patient's mouth, nose, throat, or shallow trachea.
5. Shampooing basin: includes a single application of shampooing a bedridden patient's hair in bed.
6. Bath machine: includes a single application of moving a patient to the bathroom for bathing.
7. Rehabilitation machine for hands and legs: includes a single application of rehabilitating the hands and legs of an apoplexy patient.
8. Weighing frame: includes a single application of slinging a patient for weighing.
9. Rehabilitative walking machine: includes a single application of rehabilitating an apoplexy patient by walking.
10. “Multipurpose body-turn-over apparatus” by the present inventor (Taiwan utility patent publication number 387249; U.S. Pat. No. 6,321,398 B1):
   (1) Only the lateral (the left and right direction of the patient) turning rod is designed; no longitudinal (the head and leg direction of the patient) turning rod is available. Hence, there is no lateral turning operations such as slinging the wheelchair in the sit position or turning laterally for lifting the hip and the chest.
   (2) The male shell of the lifting frame slips into the female shell for moving up and down. Because the female shell has a basic length, the lifting range is relatively high. Due to the limited lifting path, the demand is not practically satisfied.
   (3) The net having a folding board inside hooks the sling for turning. However, the folding board has the disadvantages of increasing cost, heaviness, interference, and uneasy to fold and clean.
11. “Assistive turning device having lifting function” (Taiwan utility patent publication number M416461: The lifting mechanism and the turning device are different from the present invention.

Although the various care apparatuses for apoplexy patients, patients in the vegetative state, or bedridden patients described above have respective functions, there is no an integrated device for caring. In addition to higher purchasing costs, they occupy space. Besides, they cannot satisfy the overall demands of home care and rehabilitation.

### SUMMARY

For solving the problems in the prior art, the present invention provides a device for turning over and transferring the patient. The device according to an embodiment of the present invention comprises a base, a lifting mechanism, an extension arm, a cantilever beam, and a turn driving device. The lifting mechanism comprises a lifting post and a lift driving device. The lifting post is fixed to the base; the lift driving device is fixed to the lifting post. The extension arm has a first end and a second end. The lift driving device is operatively connected to the first end for driving the extension arm to move up and down along the lifting post. The cantilever beam is connected to the second end and extending away from the lifting post. The turn driving device comprises a motor reducer, a revolutionary shaft, and two turning shafts. The motor reducer is connected pivotally to the cantilever beam. The revolutionary shaft is connected to the motor reducer; the revolutionary shaft rotates when it is driven by the motor reducer. The two turning shafts are fixed to both ends of revolutionary shaft, respectively, and turned relative to the motor reducer as the revolutionary shaft rotates.

The device for turning over and transferring the patient according to another embodiment of the present invention comprises a base, a lifting mechanism, an extension arm, a cantilever beam, a turn driving device, and a bed-shaped mattress. The lifting post is fixed to the base. The extension arm has a first end and a second end. The first end is operatively connected to the lifting mechanism. The cantilever beam is connected to the second end and extending away from the lifting post. The turn driving device comprises a motor reducer, a revolutionary shaft, and two turning shafts. The motor reducer is connected pivotally to the cantilever beam. The revolutionary shaft is connected to the motor reducer; the revolutionary shaft rotates when it is driven by the motor reducer. The two turning shafts are fixed to both ends of revolutionary shaft, respectively, and turned relative to the motor reducer as the revolutionary shaft rotates. The bed-shaped mattress comprises a main pad and a head pad. The head pad is connected to the edge of the main pad. The main pad and the head pad comprise a plurality pairs of pad lugs. Each pair of pad lugs is disposed on both sides of the main pad or the head pad symmetrically. Each pair of pad lugs can be hung to the turning shaft selectively by means of at least a sling.

The device for turning over and transferring the patient according to still another embodiment of the present invention comprises a base, a lifting mechanism, an extension arm, a cantilever beam, a turn driving device, an assembly frame, and a bathing tub. The lifting post is fixed to the base. The extension arm has a first end and a second end. The first end is operatively connected to the lifting mechanism. The cantilever beam is connected to the second end and extending away from the lifting post. The turn driving device comprises a motor reducer, a revolutionary shaft, and two turning shafts. The motor reducer is connected pivotally to the cantilever beam. The revolutionary shaft is connected to the motor reducer; the revolutionary shaft rotates when it is driven by the motor reducer. The two turning shafts are fixed to both ends of revolutionary shaft, respectively, and turned relative to the motor reducer as the revolutionary shaft rotates. The assembly frame comprises a plurality of fixing posts and a plurality of frame lugs. The frame lugs are hung to the turning shaft by means of at least a sling. The bathing tub comprises a plurality of fixing belts; each fixing belt is fixed to the corresponding fixing post.

To sum up, the device for turning over and transferring the patient according to the present invention is provided mainly for achieving the purpose of integrated cares for the apoplexy patients, the patients in the vegetative state, or the bedridden patients. The device for turning over and transferring the patient according to the present invention mainly comprises a base, a lifting mechanism, an extension arm, a cantilever beam, and a turn driving device, which can be disassembled and assembled. Specifically, the device for turning over and transferring the patient according to the present invention can switch between lateral (the left and right direction) and longitudinal (the head and leg direction) turning functions by means of the revolutionary shaft and the turning shafts contained in the turn driving device. In addition to being used with the bed-shaped mattress and the sling (including slings of various functions) described above, the device for turning over and transferring the patient according to the present invention can also be used with hooks (including hooks on the turning shafts and hooks on the slings), pulling handles, leg-lifting boards, bottom-washing tray, hair-washing tray, on-bed bathing tub, washing tools, assemble frames, vest slings. Under the instructions of professional physicians as well as safe and appropriate operations, the following purposes can be achieved:
1. Patients can perform turning exercise or the side lying positions of patients can be altered periodically, namely, changing the pressure point, for preventing bedsores.
2. Patients on bed can be slung highly for facilitating moving, changing bed sheets, or placing other accessories.
3. Caregivers can clean patients' hair on bed.
4. Caregivers can wash patients on bed.
5. Caregivers can clean patients' fecal matters, wash patients' bottoms, and change diapers on bed.
6. Caregivers can operate independently. Besides, the bed-shaped mattress can be placed anywhere for slinging patients to wheelchairs or back to beds.
7. Caregivers can percuss patients for expelling phlegm deep inside lower lungs to noses or mouths. Then use suction machines to draw out the phlegm.
8. Caregivers can raise and lower patients' legs repeatedly on bed for rehabilitation.
9. Caregivers can help patients to grip handles while pulling and releasing patients' both arms simultaneously or pulling and releasing patients' single arm alternately on bed.
10. Caregivers can help patients to practice sitting using their upper bodies, lying down, or standing up and sitting down on bedsides.

In addition, according to an embodiment of the present invention, the lifting mechanism described above further comprises an insertion socket and a lifting socket. The insertion socket is provided so that the first end of the extension arm can insert thereto. The lift driving device is connected to the insertion socket for driving the insertion socket to drive the extension arm to move up and down with respect to the lifting post. The lifting socket is put around the lifting post and fixed together with the insertion socket, making them to move up and down along the lifting post. The lifting post passes through both ends of the lifting socket.

Accordingly, the device for turning over and transferring the patient according to the present invention has the hollow lifting socket around the lifting post to make the lifting socket move up and down between two ends of the lifting post. In compared with the method according to the prior art, which has the lifting frame moving up and down by slipping the top male shell into the bottom female shell as described above, the combination of the lifting socket and post according to the present invention can increase the lifting range effectively, and thus making it more suitable for practical applications.

### BRIEF DESCRIPTION OF THE DRAWINGS

FIG. 1A shows a three-dimensional view of the device for turning over and transferring the patient according to an embodiment of the present invention;

FIG. 1B shows a partial exploded view of the device for turning over and transferring the patient in FIG. 1A;

FIG. 1C shows a partial exploded view of the device for turning over and transferring the patient in FIG. 1A;

FIG. 2A shows a top view of the base in FIG. 1A;

FIG. 2B shows a front view of the base in FIG. 1A;

FIG. 3A shows a side view of the device for turning over and transferring the patient in FIG. 1A;

FIG. 3B shows a partial view of the turn driving device in FIG. 3A;

FIG. 4A shows a schematic view of the bed-shaped mattress used with the turning and lifting device in FIG. 1A;

FIG. 4B shows a schematic view of the vest sling used with the device in FIG. 1A;

FIG. 5A shows a schematic diagram of turning on bed by using the bed-shaped mattress with the device according to the present invention;

FIG. 5B shows a schematic diagram of slinging above bed by using the bed-shaped mattress with the device according to the present invention;

FIG. 6A shows a schematic diagram of washing hair on bed by using the hair-washing tray with the device according to the present invention;

FIG. 6B shows a schematic diagram of the hair-washing tray in FIG. 6A;

FIG. 6C shows a schematic diagram of the washing tools used by the hair-washing tray in FIG. 6A;

FIG. 7A shows a schematic diagram of bathing on bed by using the bathing tub with the device according to the present invention;

FIG. 7B shows a schematic diagram of the bathing tub in FIG. 7A;

FIG. 7C shows a schematic diagram of the assembly frame used by the bathing tub in FIG. 7A;

FIG. 7D shows a side view of the long crutch in FIG. 7C;

FIG. 8A shows a schematic diagram of washing bottom on bed by using the leg-lifting board and the bottom-washing tray with the device according to the present invention;

FIG. 8B shows a schematic diagram of the leg-lifting board in FIG. 8A;

FIG. 8C shows a schematic diagram of the bottom-washing tray in FIG. 8A;

FIG. 9A shows a side view of slinging the wheelchair by using the bed-shaped mattress with the g device according to the present invention;

FIG. 9B shows a front view of slinging the wheelchair by using the bed-shaped mattress with the device in FIG. 9A;

FIG. 10A shows a side view of expelling phlegm by using the assembly frame with the device according to the present invention;

FIG. 10B shows a partial front view of expelling phlegm by using the assembly frame with the device in FIG. 10A;

FIG. 11 shows a side view of leg rehabilitation on bed by using the leg-lifting board with the device according to the present invention;

FIG. 12 shows a side view of hand rehabilitation on bed by using the pulling handle with the device according to the present invention;

FIG. 13A shows a side view of sitting and lying rehabilitation on bed by using the bed-shaped mattress with the device according to the present invention; and

FIG. 13B shows a side view of standing-up and sitting-down rehabilitation on bed by using the vest sling with the device according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

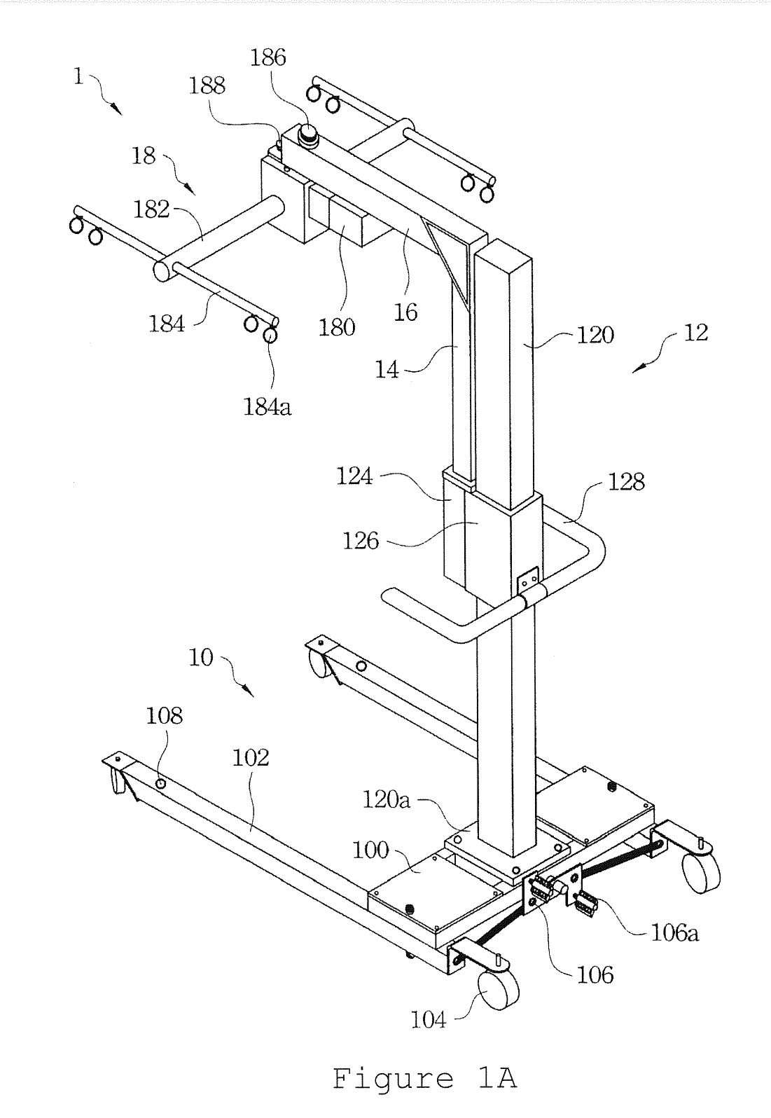

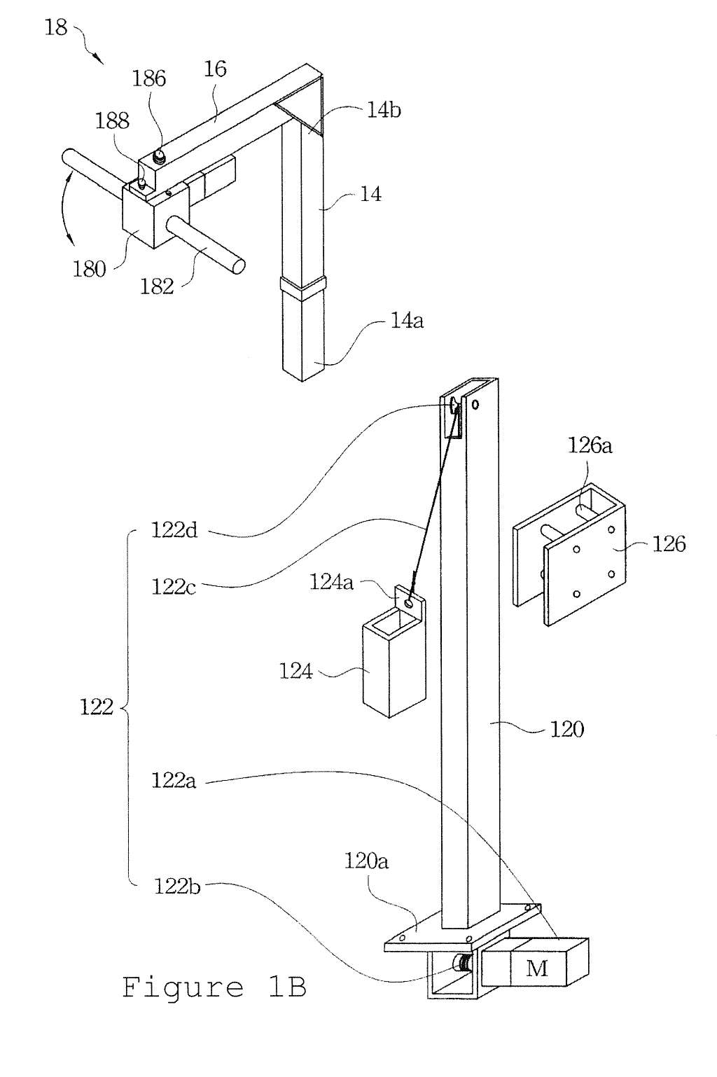

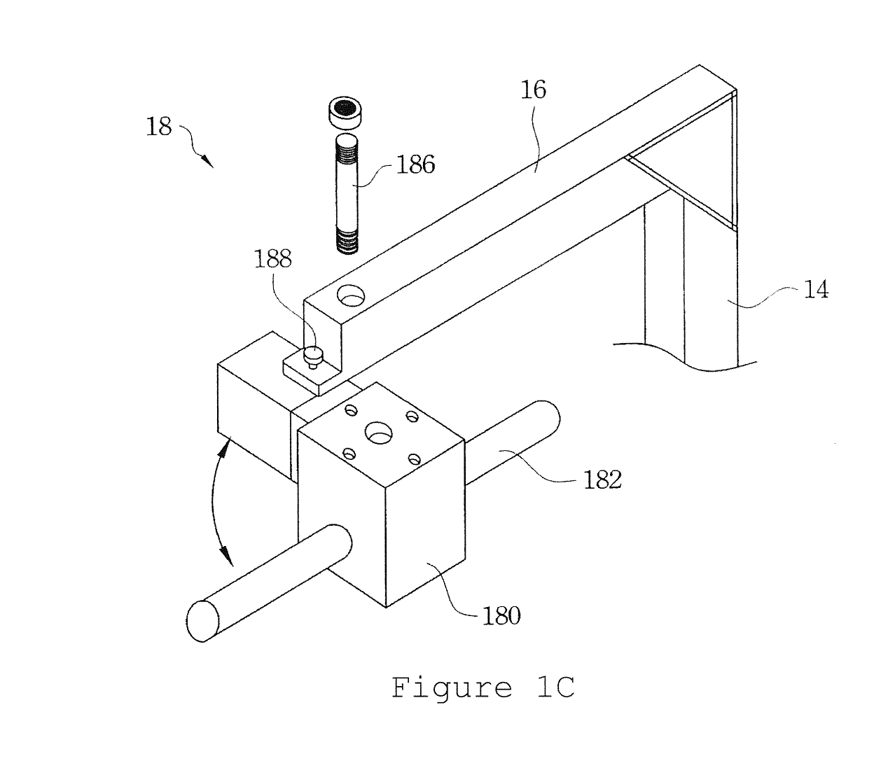

Please refer to FIGS. 1A, 1B, and 1C. FIG. 1A shows a three-dimensional view of the device for turning over and transferring the patient according to an embodiment of the present invention; FIG. 1B shows a partial exploded view of the device in FIG. 1A; and FIG. 1C shows a partial exploded view of the device in FIG. 1A.

As shown in FIG. 1A and FIG. 1B, a device 1 for turning over and transferring the patient according to the present embodiment comprises a base 10, a lifting mechanism 12, an extension arm 14, a cantilever beam 16, and a turn driving device 18. The base 10 of the device 1 comprises a base box 100, base crossbeams 102, wheels 104, a crossbeam spreading mechanism 106, pedals 106a, and pedal switches 108. The base crossbeams 102 of the base 10 are disposed on both sides of the base box 100, respectively. The wheels 104 of the base 10 are disposed at the front and the rear ends of the base crossbeams 102 and can be locked selectively. The lifting mechanism 12 of the device 1 comprises a lifting post 120, a lift driving device 122, an insertion socket 124, a lifting socket 126, and a handling frame 128. The lifting post 120 of the lifting mechanism 12 includes a connecting plate 120a. Hence, the lifting post 120 can be locked to the base box 100 of the base 10 via the connecting plate 120a. The lift driving device 122 of the lifting mechanism 12 is fixed to the lifting post 120 and comprises a motor reducer 122a, a scrolling device 122b, a lifting cable 122c, and a fixed pulley 122d. The motor reducer 122a and the scrolling device 122b of the lift driving device 122 are disposed under the connecting plate 120a. The fixed pulley 122d of the lift driving device 122 is disposed on the top of the lifting post 120. The lifting cable 122c of the lift driving device 122 is connected to the scrolling device 122b, passing into the lifting post 120 from the bottom of the lifting post 120, and guided into and then out of the fixed pulley 122d on the top of the lifting post 120. The insertion socket 124 of the lifting mechanism 12 has a handle 124a. The lifting cable 122c of the lift driving device 122 passes through the handle 124a of the insertion socket 124. Nonetheless, the present invention is not limited to this. The lifting cable 122c described above can be replaced by a lifting belt, a lifting chain, or similar devices. The lifting socket 126 of the lifting mechanism 12 is put around the lifting post 120. Besides, the lifting post 120 emerges from both ends of the lifting socket 126. Furthermore, the lifting socket 126 of the lifting mechanism 12 includes rollers 126a; the lifting post 120 is clipped within the rollers 126a. In addition, the lifting socket 126 of the lifting mechanism 12 and the insertion socket 124 are fixed to each other. The handling frame 128 of the lifting mechanism is fixed to the lifting socket 126 with both ends bending toward the insertion socket 124. The extension arm 14 of the device 1 has a first end 14a and a second end 14b. The insertion socket 124 of the lifting mechanism 12 is used to be inserted by the first end 14a of the extension arm 14. The cantilever beam 16 of the device 1 is connected to the second end 14b of the extension arm 14 and extends the lifting post 120 of the lifting mechanism 12 to the direction away from the lifting post 120.

As shown in FIGS. 1B and 1C, the turn driving device of the device according to the present embodiment comprises a motor reducer 180, a revolutionary shaft 182, turning shafts 184, a bolt shaft 186, and an orientation plug 188. The bolt shaft 186 of the turn driving device 18 passes through the cantilever beam 16 of the device 1. The motor reducer 180 of the turn driving device 18 is connected pivotally with the cantilever beam 16 via the bolt shaft 186. According to the present embodiment, the axis of the bolt shaft 186 of the turn driving device 18 is roughly parallel with the extension arm 14 and the lifting post 120 of the lifting mechanism 12. The revolutionary shaft 182 of the turn driving device 18 is connected with and passing through the motor reducer 180. Besides, the axis of the revolutionary shaft 182 is roughly perpendicular to the axis of the bolt shaft 186. The two turning shafts 184 of the turn driving device 18 are fixed to both ends of the revolutionary shaft 182, respectively; the axis of each turning shaft 184 is roughly perpendicular to the axis of the revolutionary shaft 182. In other words, the motor reducer 180, the revolutionary shaft 182, and the turning shaft 184 of the turn driving device 18 can rotate about the axis of the bolt shaft and turn horizontally about the cantilever beam 16. The revolutionary shaft 182 and the turning shaft 184 can also rotate about the axis of the revolutionary shaft and turn vertically about the motor reducer 180. In addition, the orientation plug 188 of the turn driving device 18 passes through the cantilever beam 16. Thereby, after the motor reducer 180 rotates about the axis of the bolt shaft 186 and turns horizontally about the cantilever beam 16 to the required angle, the orientation plug 188 can be used for fixing the angle between the motor reducer 180 and the cantilever beam 16.

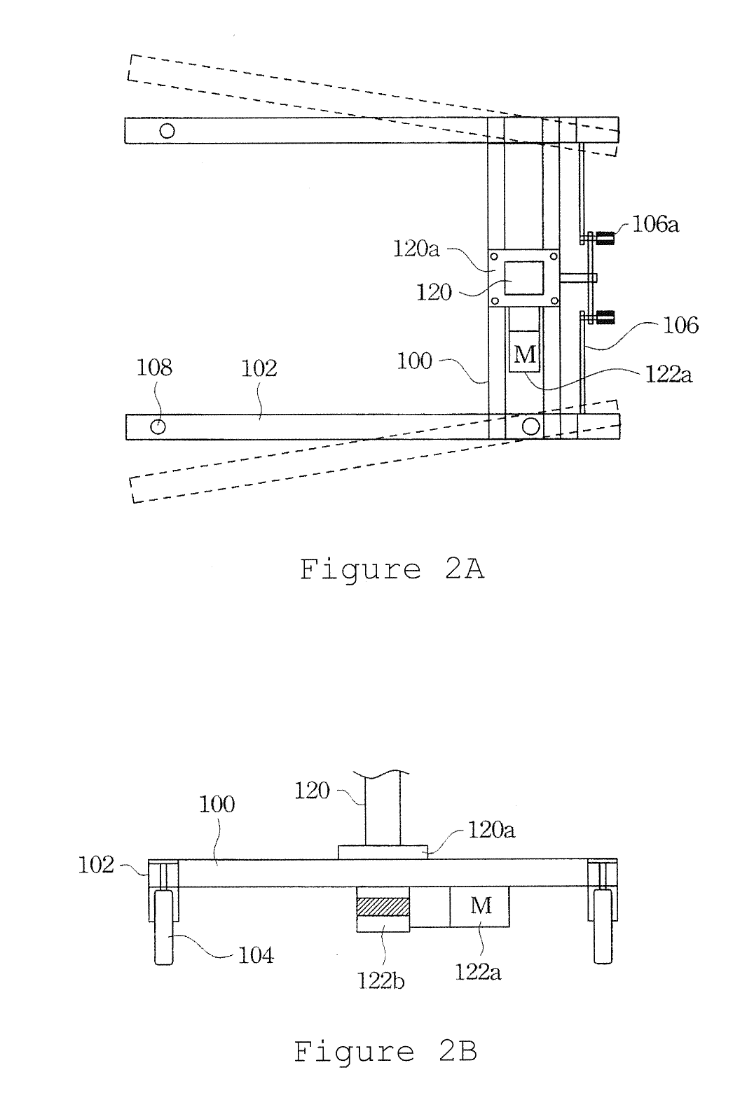

Please refer to FIGS. 2A and 2B. FIG. 2A shows a top view of the base 10 in FIG. 1A; and FIG. 2B shows a front view of the base 10 in FIG. 1A.

As shown in FIGS. 2A and 2B, the spread of the base crossbeams on both sides of the base of the device according to the present embodiment can be adjusted by stamping the left and right pedals 106a of the crossbeam spreading mechanism 106. The connecting plate 120a of the lifting post 120 is locked on the base box 100 of the base 10. Thereby, the connecting plate 120a of the lifting post 120 is located above the base box 100; the motor reducer 122a and the scrolling device 122b of the lift driving device 122 locked to the connecting plate 120a are located below the base box 100.

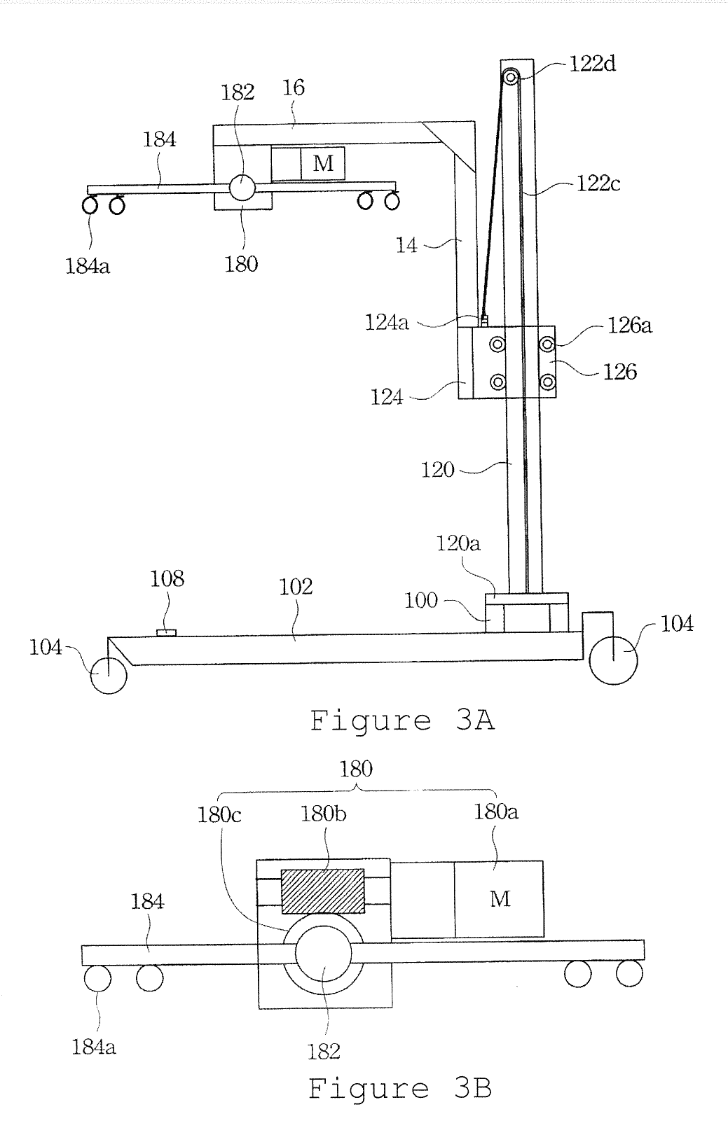

Please refer to FIGS. 3A and 3B. FIG. 3A shows a side view of the device in FIG. 1A; and FIG. 3B shows a partial view of the device in FIG. 3A.

As shown in FIGS. 3A and 3B, the device 1 according to the present embodiment uses the motor reducer 122a under the base box 100 of the base 10 to reduce the speed and rotate the scrolling device 122b to scroll the lifting cable 122c. Thereby, the lifting cable 122c can raise or lower the connected handle 124a via the fixed pulley 122d located on the top of the lifting post 120 and thus driving the lifting socket 126 to move up and down together with the insertion socket 124 along the lifting post 120 using its rollers 126a. Besides, the extension arm 14 inserted to the insertion socket 124 also moves up and down together with the insertion socket 124 along the lifting post 120. Thereby, the device 1 according to the present invention can adjust the location in height of the cantilever beam 16. In addition, according to the present embodiment, the motor reducer 180 of the turn driving device 18 comprises an electric motor 180a, a worm 180b, and a worm gear 180c. The motor reducer of the turn driving device 18 can use the electric motor 180a to rotate the worm 180b and drive the worm gear 180c, and hence driving the revolutionary shaft 182 to rotate about the motor reducer 180. Because the two turning shafts 184, whose lengths are adjustable, of the turn driving device 18 are fixed to both ends of the revolutionary shaft 182, respectively, the two turning shafts 184 will be turned together with the revolutionary shaft 182 about the motor reducer 180. Nonetheless, the transmission method of the motor reducer 180 for turning the revolutionary shaft 182 is not limited to the present embodiment.

Moreover, as shown in FIG. 1A and FIG. 3A, according to the present embodiment, the pedal switches 108 of the base 10 are disposed on the base crossbeam 102 for enabling the lifting mechanism 12 and operating the cantilever beam 16 to move up and down. However, the present invention is not limited to the embodiment. According to another embodiment, an extra manual controller can be adopted for enabling the lifting mechanism 12 and operating the cantilever beam 16 to move up and down.

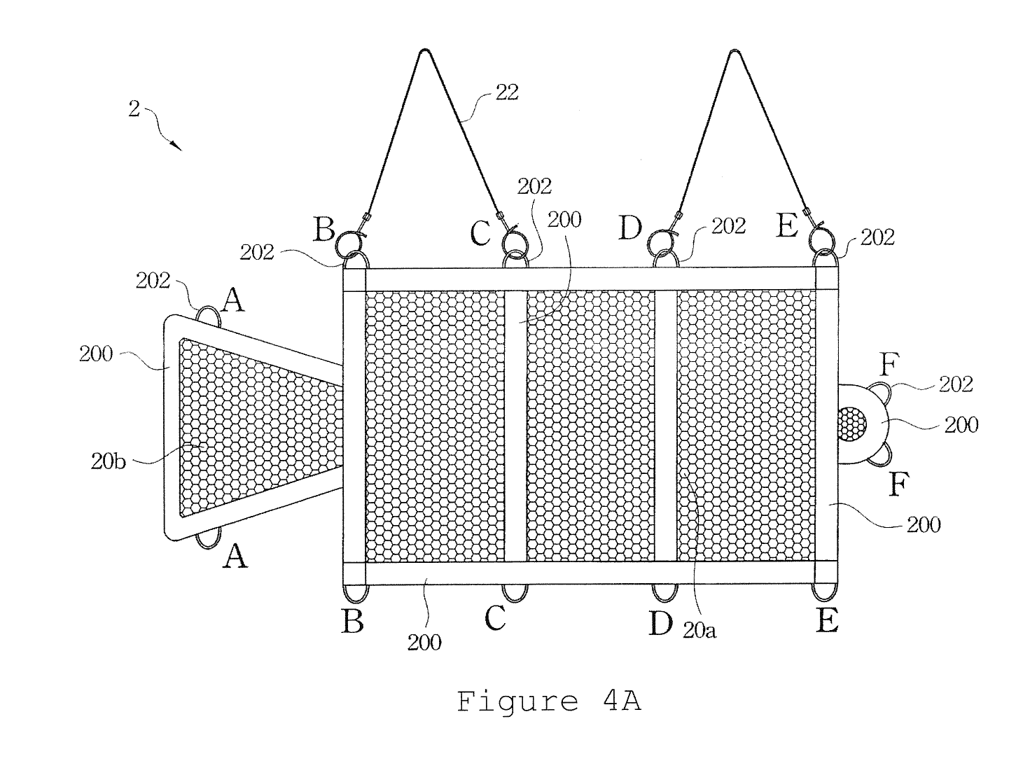

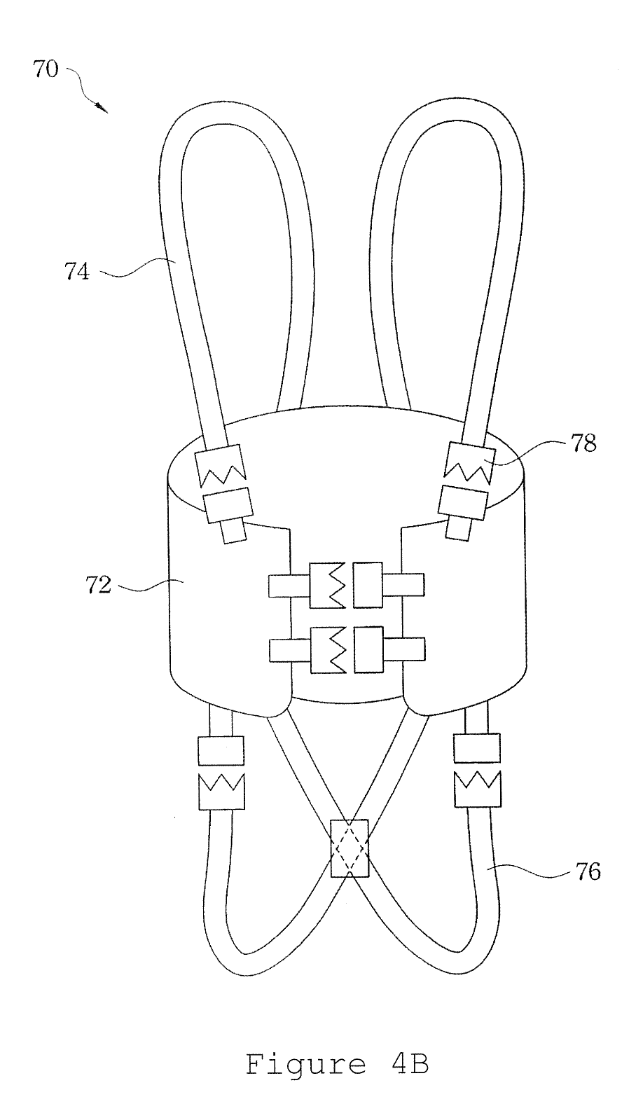

Please refer to FIG. 4A, which shows a schematic view of the bed-shaped mattress used with the device in FIG. 1A.

As shown in FIG. 1A and FIG. 4A, according to the present embodiment, the bed-shaped mattress 2 applicable to the device 1 comprises a main pad 20a and a head pad 20b. The head pad 20b of the bed-shaped mattress 2 is connected to the edge of the main pad 20a. The main pad 20a of the bed-shaped mattress 2 and the head pad 20b comprise a plurality pairs of pad lugs 202. Each pair of the pad lugs 202 of the bed-shaped mattress 2 is disposed symmetrically on both sides of the main pad 20a or the head pad 20b. Besides, each pair of the pad lugs 202 of the bed-shaped mattress 2 can be selected to be slung to the turning shaft 184 via at least a sling 22. Furthermore, the turning shaft 184 of the turn driving device 18 includes a plurality of hooks 184a. Each pair of the pad lugs 202 of the bed-shaped mattress 2 can be selected to be slung to any hook 194a of the turning shaft 184 via the slings 22. According to the present embodiment, the head pad 20b has the A pad lugs 202 disposed symmetrically. After slung to the turning shaft 184, the head pad 20b can be used for supporting a patient's head.

The main pad 20a has the B pad lugs 202, the C pad lugs 202, the D pad lugs 202, the E pad lugs 202, and the F pad lugs 202 disposed symmetrically. After slung to the turning shaft 184, the main pad 20a can be used for supporting a patient's shoulder, chest, waist, hips, and groin, respectively. The main pad 20a and the head pad 20b of the bed-shaped mattress 2 include a plurality of reinforcing bands stitched thereto. In addition, the pairs of pad lugs 202 described above are all disposed on the reinforcing bands 200. In particular, the reinforcing bands 200 of the main pad 20a and the head pad 20b of the bed-shaped mattress 2 are disposed on the peripheries. Because the main pad 20a has a larger area, it requires additional lateral reinforcing bands 200. Moreover, if the has pad 20b of the bed-shaped mattress 2 is not in use, it can be folded and adhered to the back of the main pad 20a.

Please refer to FIG. 4B, which shows a schematic view of the vest sling used with the turning and lifting device in FIG. 1A.

As shown in FIG. 4B, according to the present embodiment, the vest sling 70 comprises a long pad 72, chest slings 74, bottom slings 76, and a plurality of male and female buckles 78. The chest slings 74, the bottom slings 76, and the male and female buckles 78 of the vest sling 70 are stitched to the upper and lower peripheries of the long pad 72 for supporting and protecting a patient's body during rehabilitation.

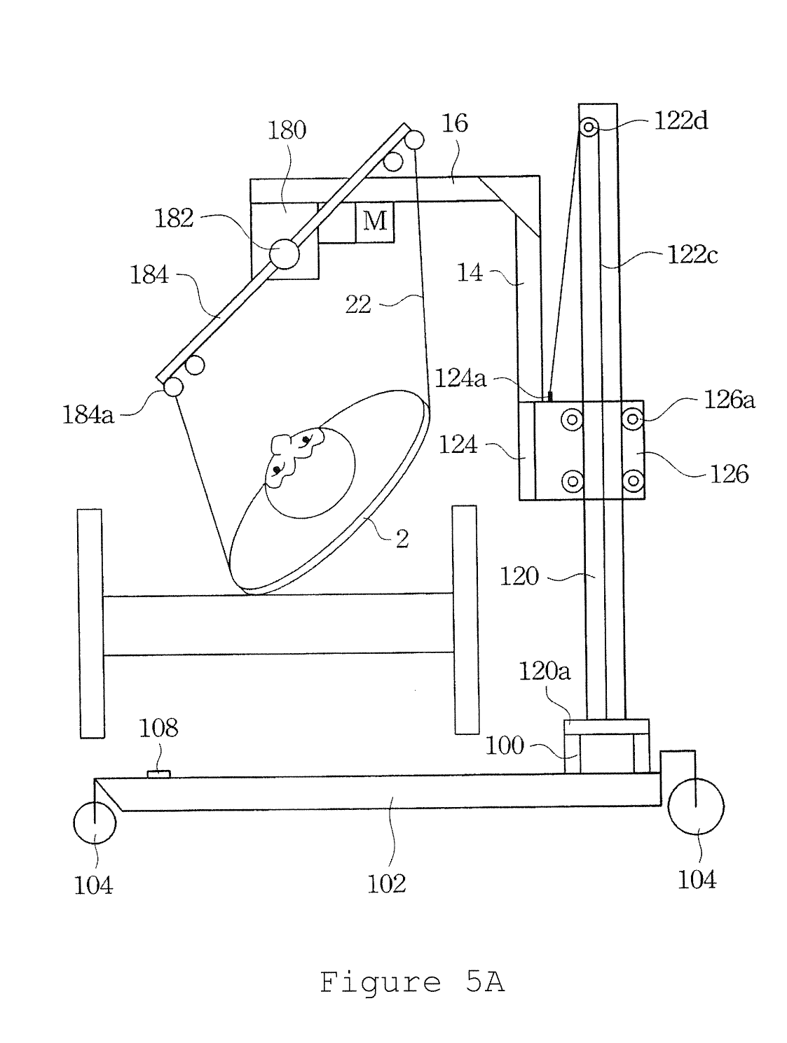

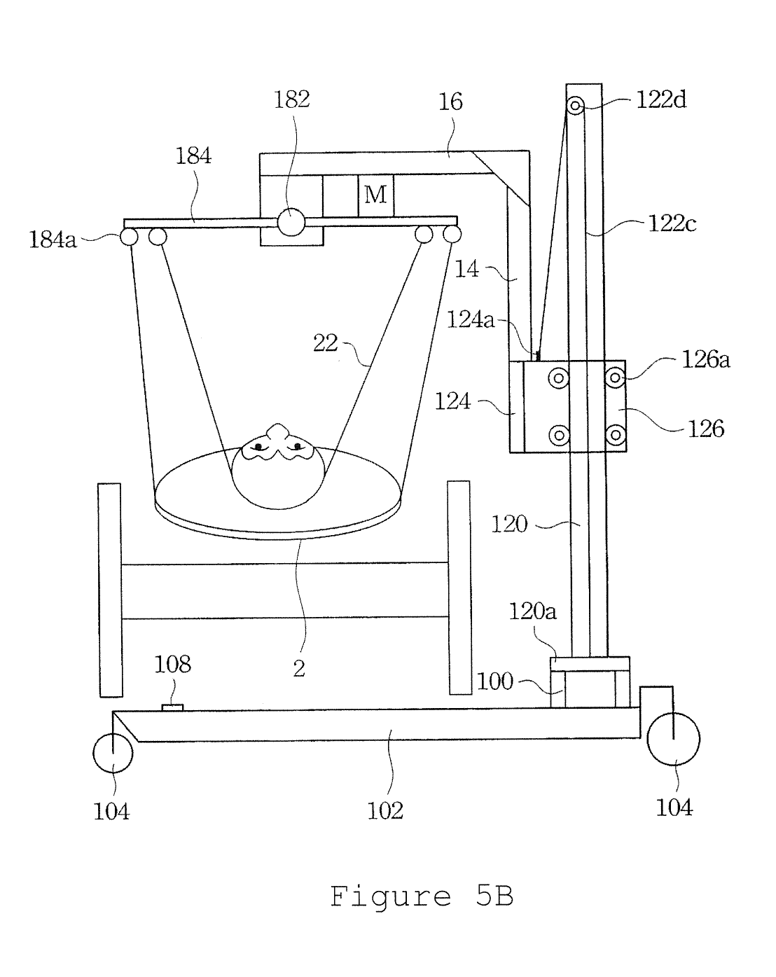

Please refer to FIG. 5A, which shows a schematic diagram of turning on bed by using the bed-shaped mattress with the device according to the present invention.

As shown in FIG. 4A and FIG. 5A, according to the present embodiment, as the cantilever beam 16 of the device 1 stops at a proper height and the hooks 184a on the turning shafts 184 of the turn driving device 184 are connected to the bed-shaped mattress 2 shown in FIG. 4A via the slings 22, the motor reducer 180 can drive the revolutionary shaft 182 and the turning shafts 184 to turn, making the slings 22 to raise one side of the bed-shaped mattress 2 and lower the other side of the bed-shaped mattress 2. If the hooks 184a on the turning shafts 184 hook to the B pad lugs 202, the C pad lugs 202, the D pad lugs 202, and the E pad lugs 202 on the main pad 20a via the slings 22 and turn, the main pad 20a provides the patient to turn his whole body on the bed and thus changing the pressure point and preventing bedsores. If the hooks 184a on the turning shafts 184 hook to the A pad lugs 202 only via the slings 22, the patient can perform the partial movement of turning his head. If the hooks 184a on the turning shafts 184 hook to the B pad lugs 202 and the C pad lugs 202 only, the C pad lugs 202 and the D pad lugs 202 only, or the D pad lugs 202 and the E pad lugs 202 only via the slings 22, the patient can perform the partial movement of turning his chest, waist, or hips.

Please refer to FIG. 5B, which shows a schematic diagram of slinging above bed by using the bed-shaped mattress with the turning and lifting device according to the present invention.

As shown in FIG. 4A and FIG. 5A, according to the present embodiment, if the hooks 184a on the turning shafts 184 hook to the A pad lugs 202, the C pad lugs 202, the D pad lugs 202, and the E pad lugs 202 simultaneously via the slings 22, the device 1 can raise or lower the main pad 20a and the head pad 20b of the bed-shaped mattress 2 by adjusting the high and low displacement of the cantilever beam 16 for slinging the patient's body and facilitating adjusting the patient's position on bed or changing bed sheets. If the hooks 184a on the turning shafts 184 hook to the A pad lugs 202 only, the B pad lugs 202 and the C pad lugs 202 only, the C pad lugs 202 and the D pad lugs 202 only, or the D pad lugs 202 and the E pad lugs 202 only via the slings 22, the device 1 can raise or lower the specific portion of the main pad 20a and the head pad 20b of the bed-shaped mattress 2 by adjusting the high and low displacement of the cantilever beam 16 for performing partial body stretches such as raising head, chest, waist, and hips.

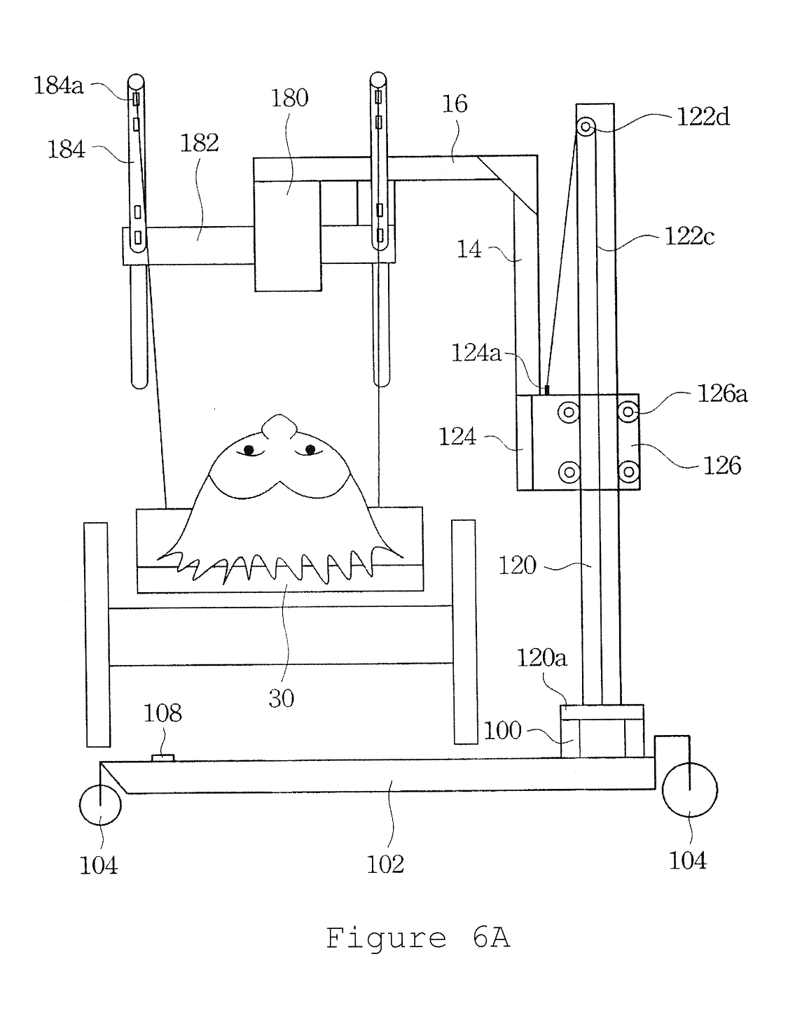

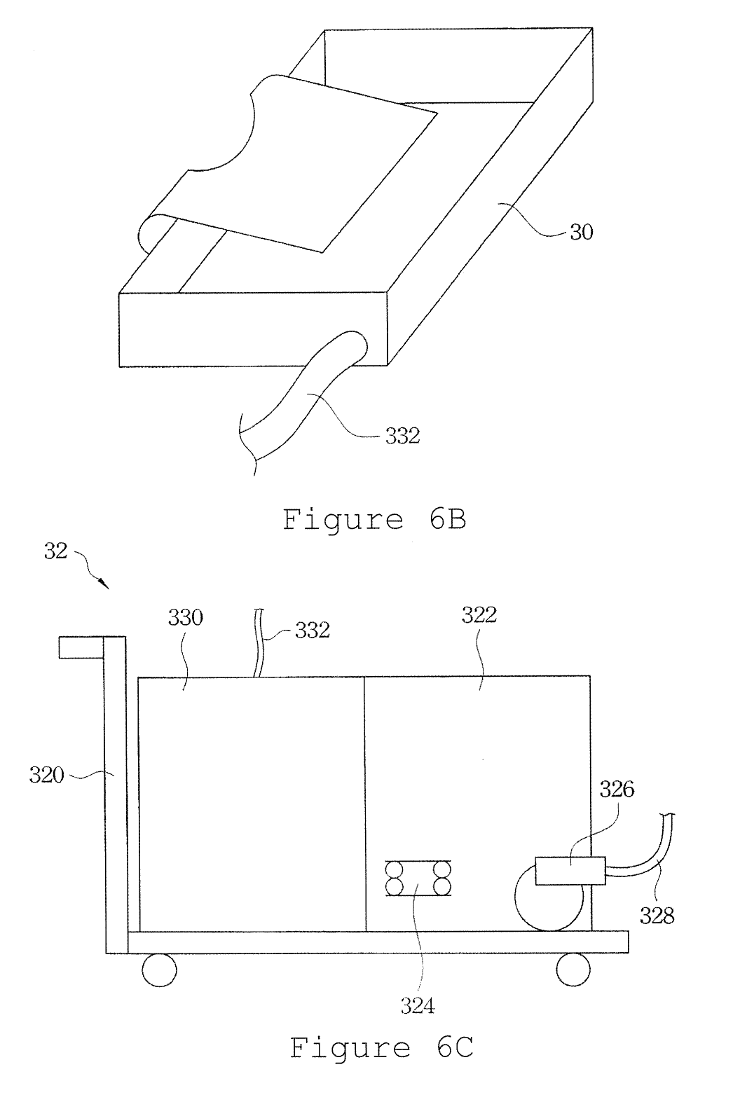

Please refer to FIGS. 6A, 6B, and 6C. FIG. 6A shows a schematic diagram of washing hair on bed by using the hair-washing tray with the device according to the present invention; FIG. 6B shows a schematic diagram of the hair-washing tray in FIG. 6A; and FIG. 6C shows a schematic diagram of the washing tools used by the hair-washing tray in FIG. 6A.

As shown in FIGS. 6A, 6B, and 6C, according to the present embodiment, when the cantilever beam 16 of the device 1 stops at a proper height and hooks 184a on the turning shafts 184 of the turn driving device 18 are connected to the B pad lugs 202 of the bed-shaped mattress 2 in FIG. 4A via the slings 22, the motor reducer 180 drives the revolutionary shaft 182 and the turning shafts 184 to turn. The slings 22 lift a potion of the main pad 20a and thus raising the patient's shoulder and placing the patient's head on the hair-washing tray 30 as shown in FIG. 6B. The washing tools 32 in FIG. 6C include a trolley 320, a water tank 322, a temperature-controlled geyser 324, a water pump 326, a supplying pipe 328, a waste water tank 330, and a drainpipe 332. The water tank 322 and the waste water tank 330 of the washing tools 32 are disposed on the trolley 320; the temperature-controlled geyser 324 and the water pump 326 of the washing tools 32 are disposed at the water tank 322. The temperature-controlled geyser 324 of the washing tools 32 is used for adjusting the temperature of the water tank 322; the water pump 326 guides the water in the water tank 322 to the hair-washing tray 30 via the supplying pipe 328. The waste water of washing the patient's hair is guided to the waste water tank 330 from the hair-washing tray 30 and via the drainpipe 332 of the washing tools 32. Thereby, by using the washing tools 32 together with the hair-washing tray 30, a patient's hair can be washed on bed with ease.

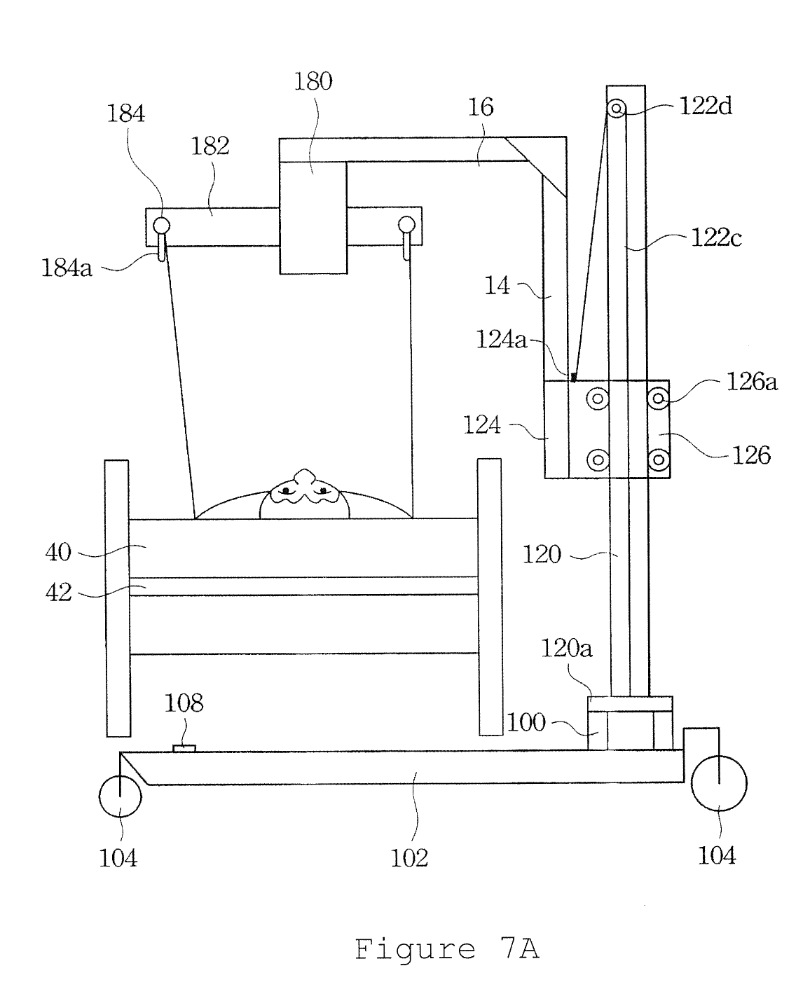

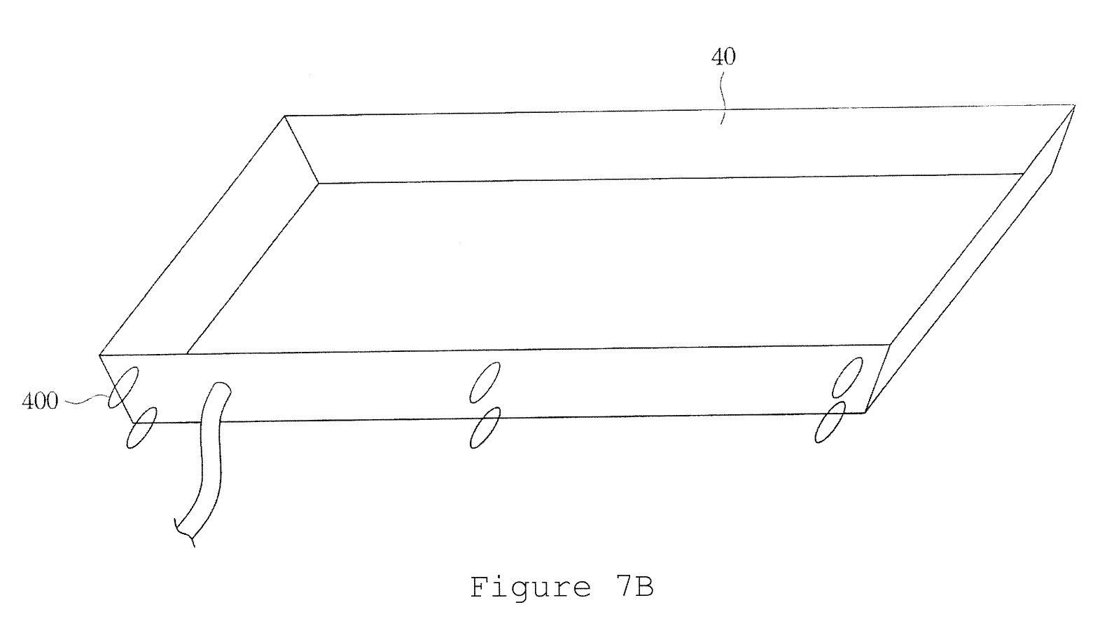

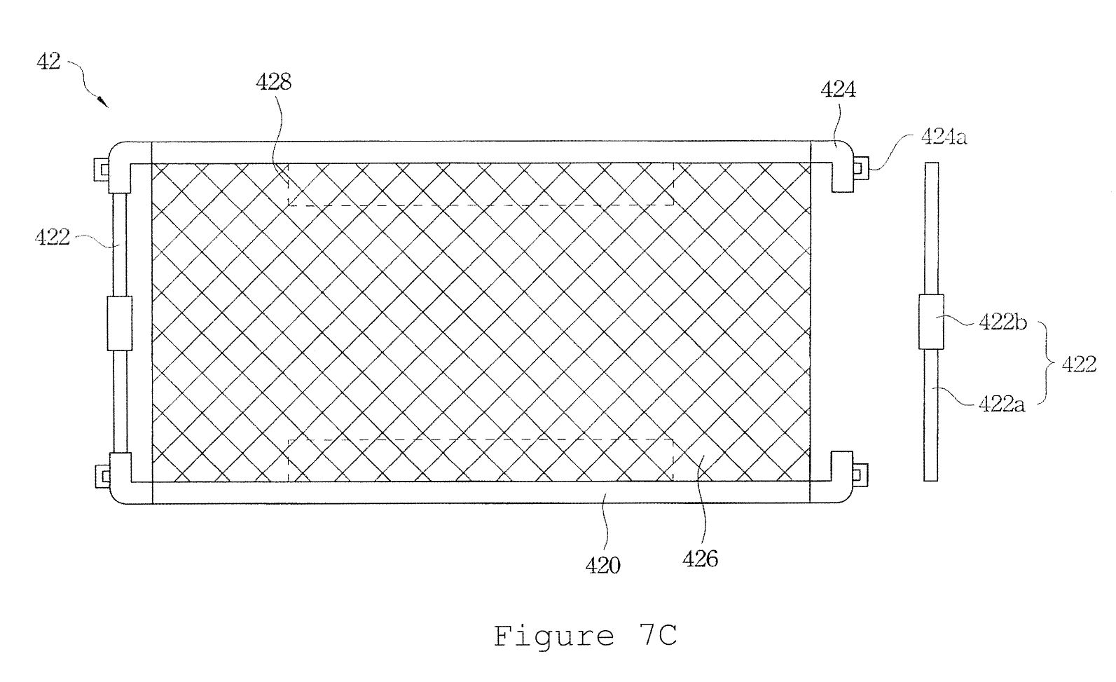

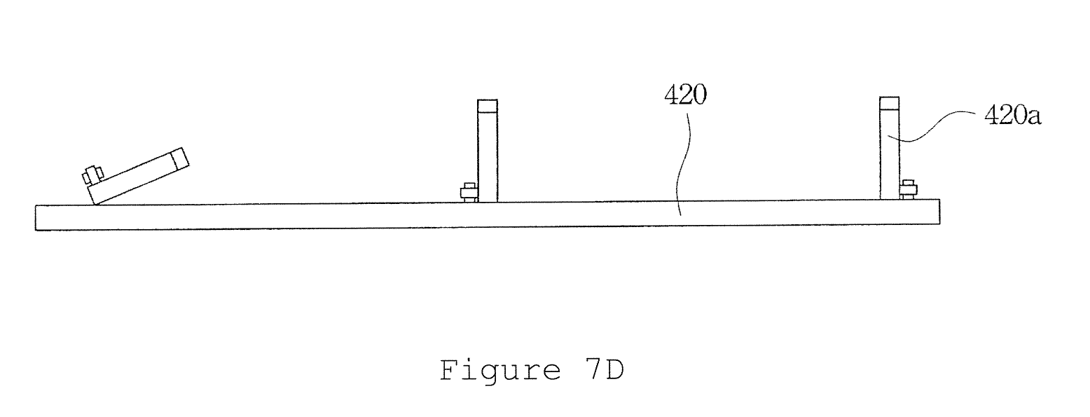

Please refer to FIGS. 7A to 7D. FIG. 7A shows a schematic diagram of bathing on bed by using the bathing tub 40 with device according to the present invention; FIG. 7B shows a schematic diagram of the bathing tub in FIG. 7A; FIG. 7C shows a schematic diagram of the assembly frame used by the bathing tub in FIG. 7A; and FIG. 7D shows a side view of the long crutch in FIG. 7C.

As shown in FIGS. 7A and 7B, according to the present embodiment, if the hooks 184a on the turning shaft 184 hook to the A pad lugs 202, the C pad lugs 202, the D pad lugs 202, and the E pad lugs 202 of the main pad 20a via the slings 22, then the device 1 can raise the bed-shaped mattress 2 by adjusting the heights of the cantilever beam 16 and thus placing the patient into the washing tub 40 in FIG. 7B.

As shown in FIGS. 7B, 7C, and 7C, the washing tub 40 is a rectangular tub formed by stitching nylon or similar waterproof materials. The washing tub 40 includes fixing bands 400 located at the tops and bottoms of the head, middle, and tail parts on both sides thereof. The assembly frame 42 includes long crutches 420, short crutches 422, bent joints 424, canvas 426, and bags 428. The assembly frame 42 is formed by two parallel short crutches 422 and two parallel long crutches 420; the bent joints 424 are used for connecting and locking between any two adjacent short crutches 422 and long crutches 420. In other words, one of the long crutches 420 and one of the short crutches 422 are connected and locked to both ends of one of the bent joints 424 and forming a closed frame. The canvas 42 of the assembly frame 42 is connected and spread between the two long crutches 420. Each short crutch 422 of the assembly frame 42 includes a telescopic casing 422b and two shafts 422a. The two shafts 422a of the short crutch 422 are connected and locked to both ends of the telescopic casing 422b. Besides, by locking into the telescopic casing 422b, the overall length of the short crutches 422 can be adjusted. Thereby, when the short crutches 422 are disassembled from the bent joints 424 and retracted, they can be held in the bags 428, and hence facilitating disassembling and storing of the assembly frame 42.

In addition, each long crutch 420 of the assembly frame 42 has fixing pillars 420a at its head, middle, and tail parts. The fixing pillars 420a can be folded with respect to the long crutches 420. The fixing bands 400 on both sides of the washing tub 40 can be thereby fixed to the corresponding pillars 420a of the long crutches 420. The bent joints 424 of the assembly frame 42 include frame lugs 424a. Hence, the assembly frame 42 of the washing tub 40 can be raised by lifting the frame lugs 424a of the bent joints 424 for draining water with ease. Then, by using the washing tools 32 in FIG. 6C, caregivers can wash a patient in the washing tub 40 on bed.

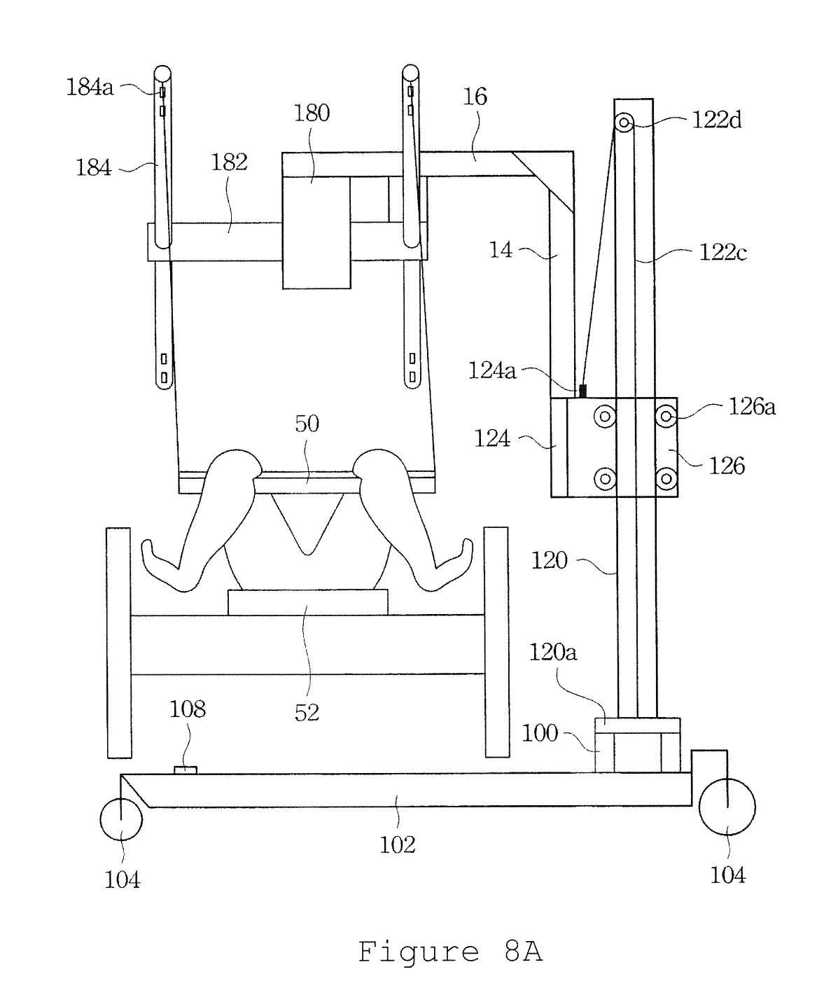

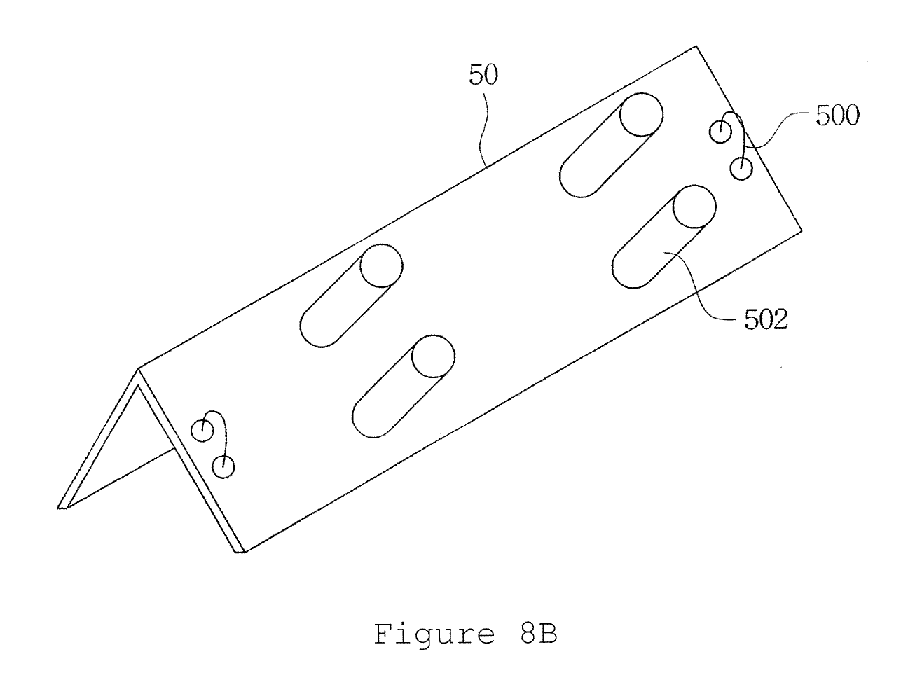

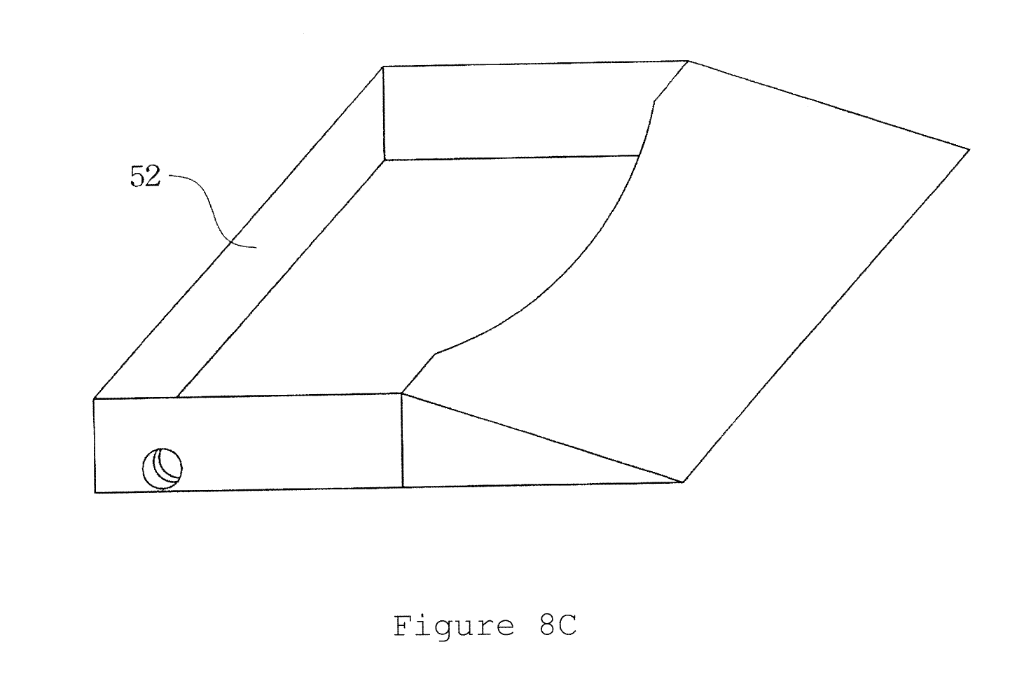

Please refer to FIGS. 8A to 8C. FIG. 8A shows a schematic diagram of washing bottom on bed by using the leg-lifting board and the bottom-washing tray with the turning and lifting device according to the present invention; FIG. 8B shows a schematic diagram of the leg-lifting board in FIG. 8A; and FIG. 8C shows a schematic diagram of the bottom-washing tray in FIG. 8A.

As shown in FIGS. 8A to 8C, according to the present embodiment, the leg-lifting board 50 includes lugs for leg-lifting board 500 and thigh-separating pillars 502. As the cantilever beam 16 of the device 1 stops at a proper height and the hooks 184a on the turning shaft 184 of the turn driving device 18 are connected to the lugs for leg-lifting board 500 of the leg-lifting board 50 shown in FIG. 8B via the slings 22, the motor reducer 180 can drive the revolutionary shaft 182 and the turning shaft 184 to turn. Thereby, the slings 22 lift the leg-lifting board 50 for lifting the patient's thighs and hips and placing the patient's hips on the bottom-washing tray 52. Accordingly, caregivers can clean the patient's fecal matters and change diapers on bed.

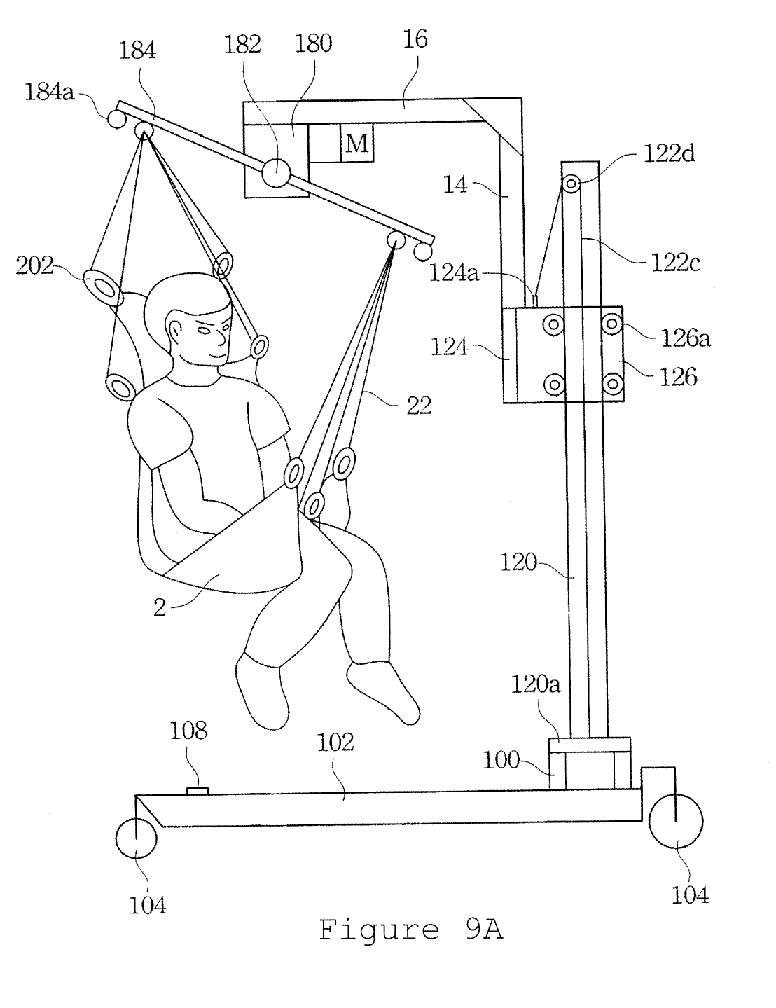

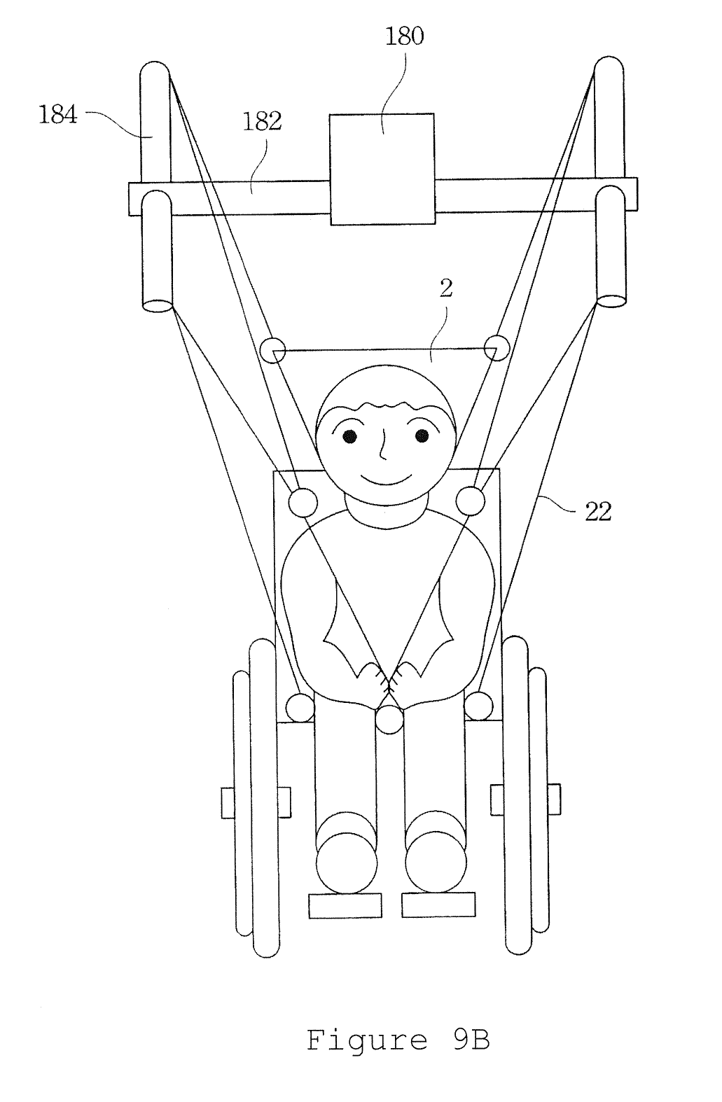

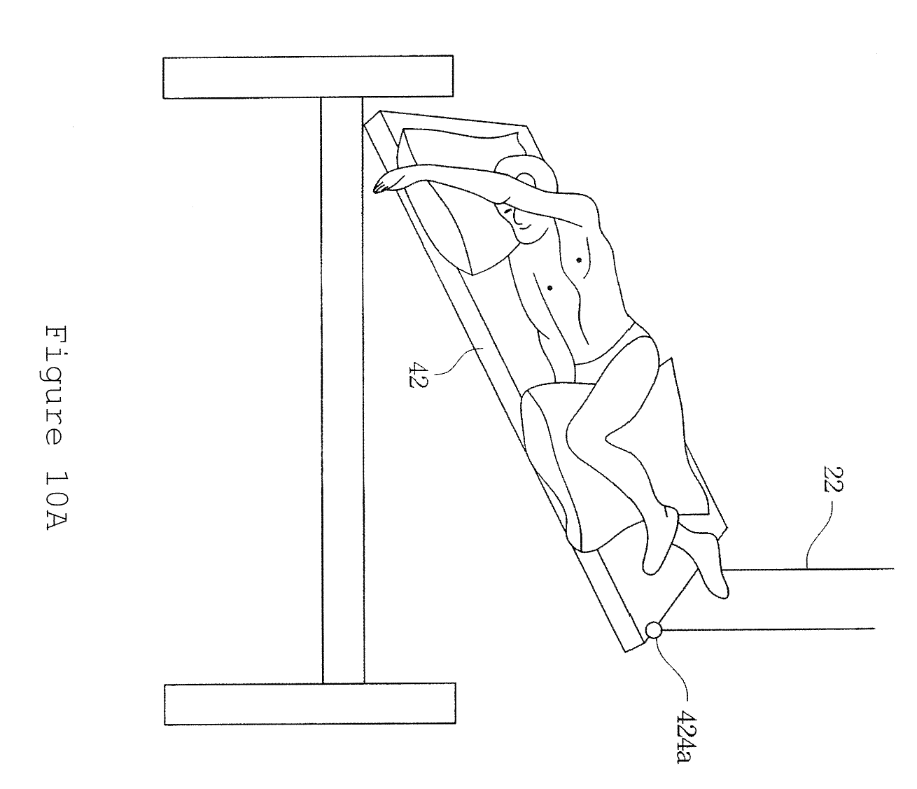

Please refer to FIG. 9A and FIG. 9B. FIG. 9A shows a side view of slinging the wheelchair by using the bed-shaped mattress with the device according to the present invention; and FIG. 9B shows a front view of slinging the wheelchair by using the bed-shaped mattress with the device in FIG. 9A.

As shown in FIGS. 9A and 9B, according to the present embodiment, as the hook 184a on one end of the turning shaft 184 of the turn driving device 18 is connected to the A pad lugs 202 and the B pad lugs 202 of the bed-shaped mattress 2 in FIG. 4A via the slings 22 and the other hooks 184a on the other end of the turning shaft 184 is connected to the E pad lugs 202 and the F pad lugs 202 of the bed-shaped mattress 2 via the other sling 22, the motor reducer 180 can drive the turning shaft 184 to turn and adjust the height of the cantilever beam 16 for lifting the bed-shaped mattress 2 and enabling the patient to move above the vacant wheelchair in the sit position. The caregiver can stamp the pedal switches 108 of the base 10 to enable the lifting mechanism 12. By supporting the patient, the caregiver can operate the cantilever beam 16 to move up and down and place the bed-shaped mattress 2 by independent operations. Then the patient can sit to the wheelchair or be slung back to the bed stably.

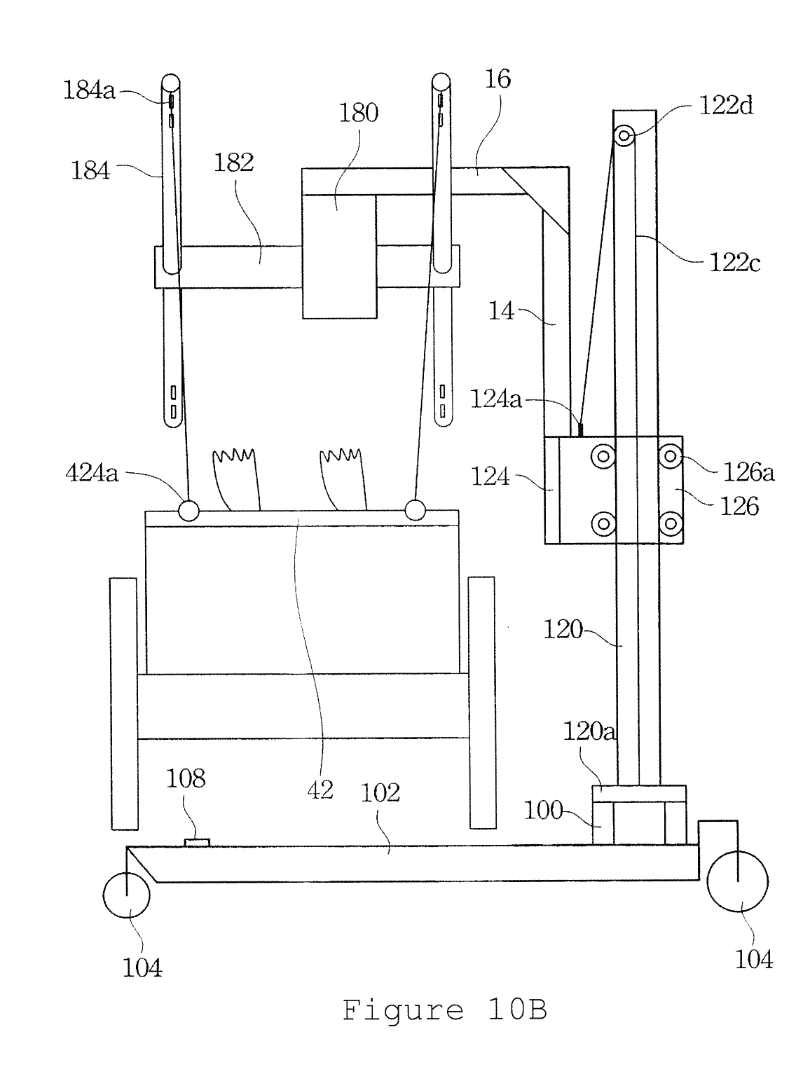

Please refer to FIG. 10A and FIG. 10B. FIG. 10A shows a side view of expelling phlegm by using the assembly frame with the device according to the present invention; and FIG. 10B shows a partial front view of expelling phlegm by using the assembly frame with the t device in FIG. 10A.

As shown in FIGS. 10A and 10B, according to the present embodiment, when the cantilever beam of the device stops at a proper height, the assembly frame 42 in FIG. 7C is placed under the patient, who is in the left or right lying position, and the hooks 184a on the turning shaft 184 of the turn driving device 18 are connected to the frame lugs 424a of the assembly frame 42 via the slings 22, the motor reducer 180 can drive the revolutionary shaft 182 and the turning shaft 184 to turn. Thereby, the slings 22 can lift the assembly frame 42 to a proper angle, making the patient in a drainage position, in which the patient's head is low and the legs are high. Consequently, the caregiver can percuss the patient and help the patient to expel the deep accumulated phlegm to the mouth. Then the phlegm can be removed using a suction machine.

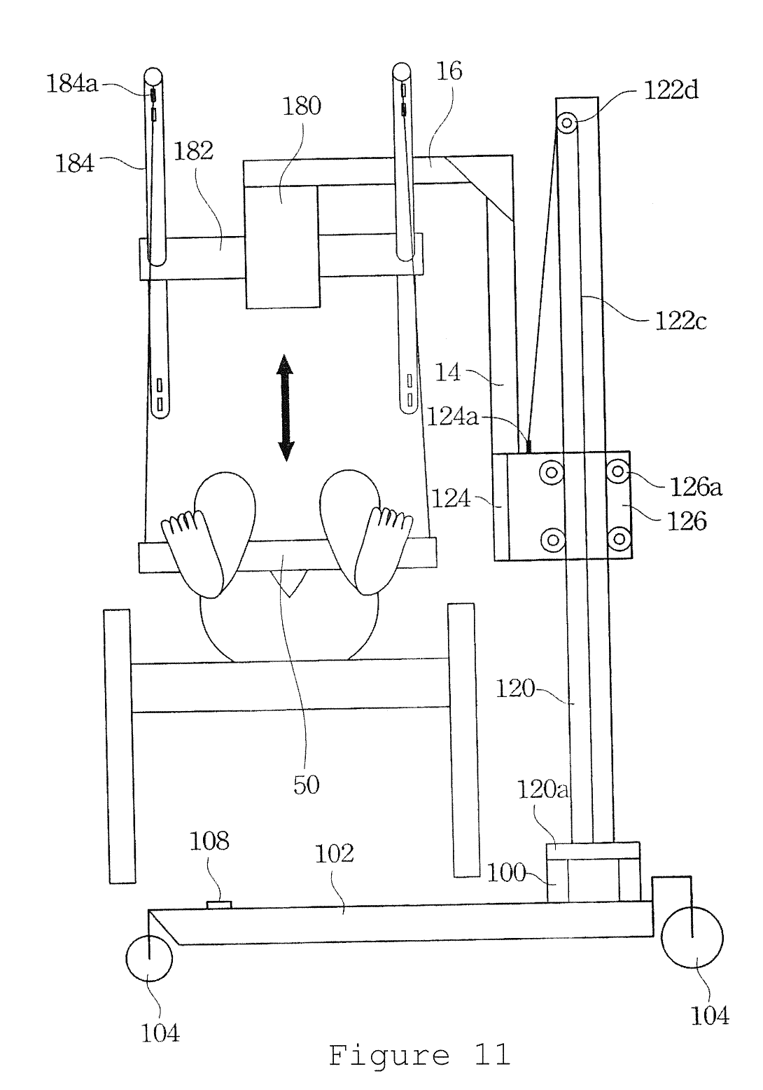

Please refer to FIG. 11, which shows a side view of leg rehabilitation on bed by using the leg-lifting board with the device according to the present invention.

As shown in FIG. 11, according to the present embodiment, as the cantilever beam 16 of the device 1 stops at a proper height and the hooks 184a on the turning shaft 184 of the turn driving device 18 are connected to the leg-lifting-board lugs 500 of the leg-lifting board 50 in FIG. 8B via the slings 22, the motor reducer 180 can drive the revolutionary shaft 182 and the turning shaft 184 to turn and thus enabling the slings 22 to lift the leg-lifting board 50 under the patient's shanks. Thereby, the patient's legs can be lifted or lowered repeatedly for rehabilitation.

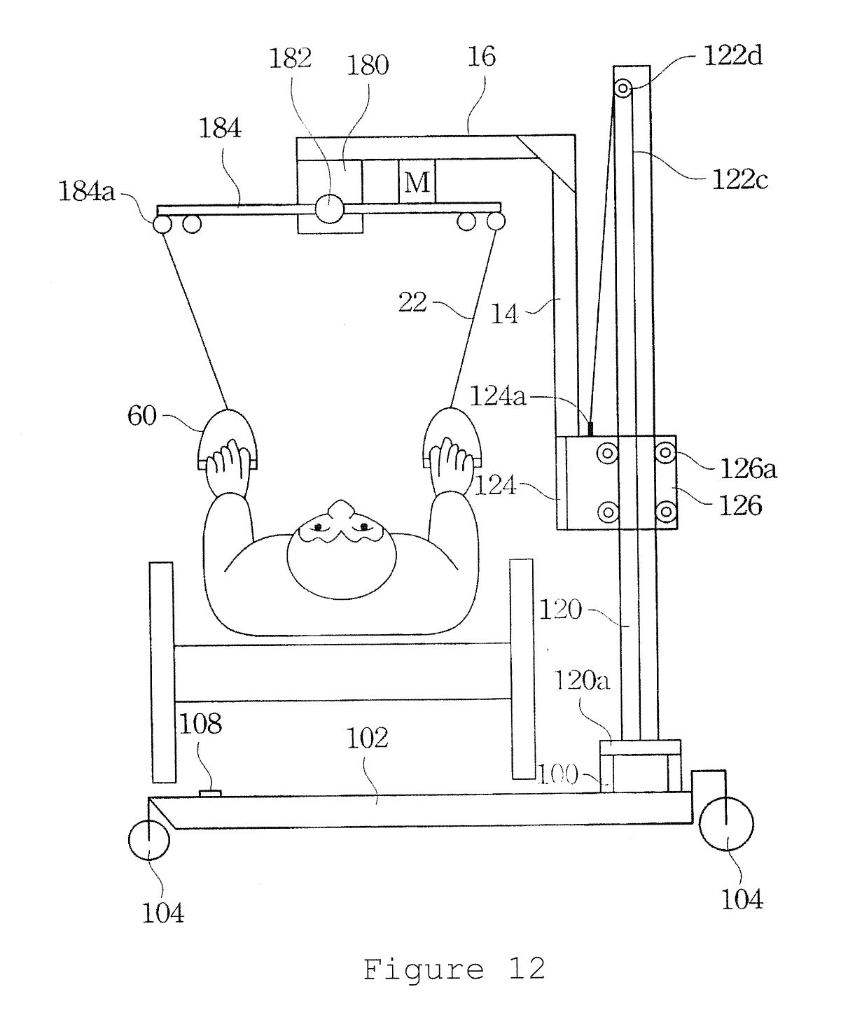

Please refer to FIG. 12, which shows a side view of hand rehabilitation on bed by using the pulling handle with the device according to the present invention.

As shown in FIG. 12, according to the present embodiment, as the cantilever beam 16 of the device 1 stops at a proper height and the two hooks 184a on both ends of the turning shaft 184 of the turn driving device 18 are connected to the two pulling handles 60 via the slings 22, the motor reducer 180 can drive the revolutionary shaft 182 and the turning shaft 184 to turn and thus enabling the slings 22 to lift and lower the two pulling handles 60 alternately. Thereby, the patient's arms can be pulled and released alternately for rehabilitation.

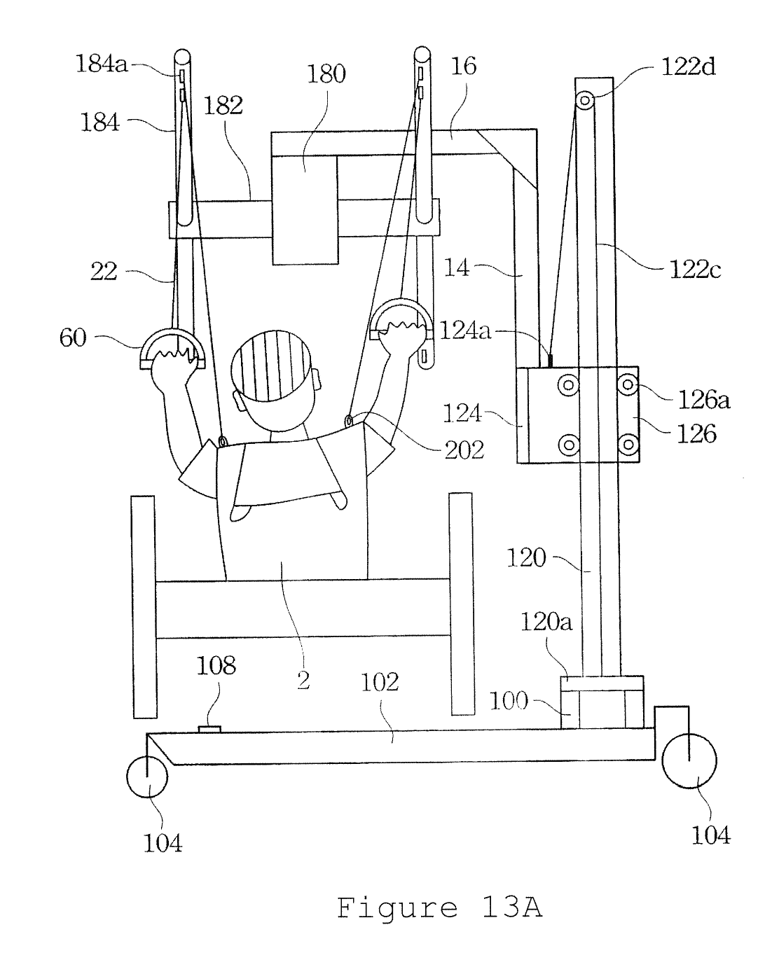

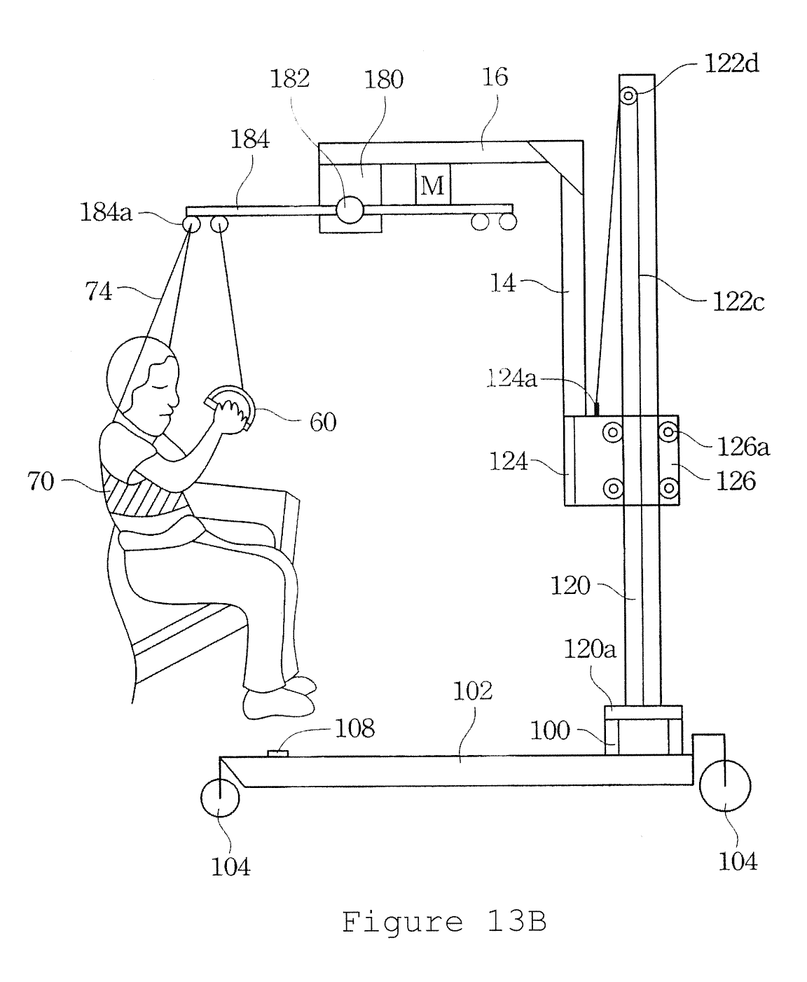

Please refer to FIG. 13A and FIG. 13B. FIG. 13A shows a side view of sitting and lying rehabilitation on bed by using the bed-shaped mattress with the device according to the present invention; and FIG. 13B shows a side view of standing-up and sitting-down rehabilitation on bed by using the vest sling with the device according to the present invention.

As shown in FIG. 13A, according to the present embodiment, as the cantilever beam of the device 1 stops at a proper height and the hooks 184a on the same ends of the two turning shafts 184 of the turn driving device 18 are connected to the B pad lugs 202 of the main pad 20a in FIG. 4A and to the pulling handle 60 in FIG. 12 via the slings 22, respectively, the motor reducer can drive the revolutionary shaft 182 and the turning shafts 184 to turn. Thereby, the slings 22 can lift the B pad lugs 202 and the pulling handle 60 simultaneously and thus helping the patient to perform the rehabilitation of sitting and lying.

As shown in FIG. 13B, according to the present embodiment, as the cantilever beam 16 of the device 1 stops at a proper height and the hooks 184a on the same ends of the two turning shafts 184 of the turn driving device 18 are connected to the vest sling 70 in FIG. 4B and to the pulling handle 60 in FIG. 12 via the chest slings 74 of the vest sling 70, the motor reducer can drive the revolutionary shaft 182 and the turning shafts 184 to turn. Thereby, the slings 22 can lift the vest sling 70 and the pulling handle 60 simultaneously and thus helping the patient to perform the rehabilitation of standing up and sitting down.

According to the detailed description of the embodiments of the present invention, obviously, the device for turning over and transferring the patient according to the present invention mainly comprises a base, a lifting mechanism, an extension arm, a cantilever beam, and a turn driving device, which can be disassembled and assembled. Specifically, the device for turning over and transferring the patient according to the present invention can switch between lateral (the left and right direction) and longitudinal (the head and leg direction) turning functions by means of the revolutionary shaft and the turning shafts contained in the turn driving device. In addition to being used with the bed-shaped mattress and the sling (including slings of various functions) described above, the device for turning over and transferring the patient according to the present invention can also be used with hooks (including hooks on the turning shafts and hooks on the slings), pulling handles, leg-lifting boards, bottom-washing tray, hair-washing tray, on-bed bathing tub, washing tools, assemble frames, vest slings. Furthermore, the device for turning over and transferring the patient according to the present invention has the hollow lifting socket around the lifting post to make the lifting socket move up and down between two ends of the lifting post. In compared with the method according to the prior art, which has the lifting frame moving up and down by slipping the top male shell into the bottom female shell as described above, the combination of the lifting socket and post according to the present invention can increase the lifting range effectively, and thus making it more suitable for practical applications.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A device for turning over and transferring the patient, comprising:
a base;
a lifting mechanism, comprising:
a lifting post, fixed to said base; and
a lift driving device, fixed to said lifting post;
an extension arm, having a first end and a second end, said lift driving device operatively connected to said first end for driving said extension arm to move up and down along said lifting post;
a cantilever beam, connected to said second end, and extending away from said lifting post; and
a turn driving device, comprising:
a motor reducer, connected pivotally to said cantilever beam;
a revolutionary shaft, connected to said motor reducer, and driven by said motor reducer and turning about said motor reducer; and
two turning shafts, fixed on both ends of said revolutionary shaft, respectively, and turning about said motor reducer along with said revolutionary shaft.

2. The device of claim 1, wherein said turning shafts can move along said revolutionary shaft, adjust the longer and short sides, and turn about said revolutionary shaft, and said turn driving device further comprises:
a bolt shaft, passing through said cantilever beam, said motor reducer connected pivotally with said cantilever beam via said bolt shaft, said revolutionary shaft passing said motor reducer, and said revolutionary shaft and said motor reducer rotating together about said bolt shaft; and
an orientation plug, passing through said cantilever beam, and fixing the rotational angle between said motor reducer and said cantilever beam.

3. The device of claim 1, wherein said lifting mechanism further comprises:
an insertion socket, inserted by said first end, and said lift driving device connected to said insertion socket for driving said insertion socket to drive said extension arm to move up and down along said lifting post; and
a lifting socket, put around said lifting post, fixed with said insertion socket, moving up and down with said insertion socket along said lifting socket, and lifting post passing through both ends of said lifting socket.

4. A device for turning over and transferring the patient, comprising:
a base;
a lifting mechanism, fixed to said base;
an extension arm, having a first end and a second end, and said first end operatively connected to said lifting mechanism;
a cantilever beam, connected to said second end, and extending away from said lifting post;
a turn driving device, comprising:
a motor reducer, connected pivotally to said cantilever beam;
a revolutionary shaft, connected to said motor reducer, and driven by said motor reducer and turning about said motor reducer; and
two turning shafts, fixed on both ends of said revolutionary shaft, respectively, and turning about said motor reducer along with said revolutionary shaft; and
a bed-shaped mattress, comprising a main pad and a head pad, said head pad connected to the edge of said main pad, said main pad and said head pad comprising a plurality pairs of pad lugs, each pair of said pad lugs disposed symmetrically on both sides of said main pad or said head pad, respectively, and each pair of said pad lugs slung selectively to said turning shafts via at least a sling.

5. The device of claim 4, wherein said turning shafts comprise a plurality of hooks, and each pair of said pad lugs can be slung selectively to any of said plurality of hooks.

6. The device of claim 4, wherein said head pad can be folded to the back of said main pad and fixed by adhesion.

7. The device of claim 4, wherein said main pad and said head pad are formed by stitching a plurality of reinforcing bands and said plurality pairs of pad lugs are disposed on said plurality of reinforcing bands.

8. The device of claim 4, wherein said turning shafts can move along said revolutionary shaft, adjust the longer and short sides, and turn about the revolutionary shaft, and said turn driving device further comprises:
a bolt shaft, passing through said cantilever beam, said motor reducer connected pivotally with said cantilever beam via said bolt shaft, said revolutionary shaft passing said motor reducer, and said revolutionary shaft and said motor reducer rotating together about said bolt shaft; and
an orientation plug, passing through said cantilever beam, fixing the rotational angle between said motor reducer and said cantilever beam.

9. A device for turning over and transferring the patient, comprising:
a base;
a lifting mechanism, fixed to said base;
an extension arm, having a first end and a second end, and said first end operatively connected to said lifting mechanism;
a cantilever beam, connected to said second end, and extending away from said lifting post;
a turn driving device, comprising:
a motor reducer, connected pivotally to said cantilever beam;
a revolutionary shaft, connected to said motor reducer, and driven by said motor reducer and turning about said motor reducer; and
two turning shafts, fixed on both ends of said revolutionary shaft, respectively, and turning about said motor reducer along with said revolutionary shaft;
an assembly frame, comprising a plurality of fixing pillars and a plurality of frame lugs, and said plurality of frame lugs slung to said turning shafts via at least a sling; and
a bathing tub, comprising a plurality fixing bands, and each fixing band fixed to said corresponding fixing pillar.

10. The device of claim 9, wherein said assembly frame comprises:
a plurality of long crutches, each of said plurality of fixing pillars disposed on said corresponding long crutch and foldable with respect to said corresponding long crutch;
a plurality of short crutches; and
a plurality of bent joints, each of said plurality of frame lugs disposed on said corresponding bent joint, and both ends of each of said plurality of bent joints locking one of said plurality of long crutches with one of said plurality of short crutches, respectively.

11. The device of claim 10, wherein each of said plurality of short crutches comprises:
a telescopic casing; and
two shafts, locked to both ends of said telescopic casing, respectively, and adjusting the length by locking into said telescopic casing.

12. The device of claim 9, wherein said turning shafts can move along said revolutionary shaft, adjust the longer and short sides, and turn about said revolutionary shaft, and said turn driving device further comprises:
a bolt shaft, passing through said cantilever beam, said motor reducer connected pivotally with said cantilever beam via said bolt shaft, said revolutionary shaft passing said motor reducer, and said revolutionary shaft and said motor reducer rotating together about said bolt shaft; and
an orientation plug, passing through said cantilever beam, fixing the rotational angle between said motor reducer and said cantilever beam.
